(19) United States
(12) Patent Application Publication
(10) Pub. No.: US 2009/0250447 A1
(43) Pub. Date: Oct. 8, 2009

(54) CAPILARY ELECTRICAL WELDING PROCESS FOR THE REPAIR OF CARBON STEEL, OF HIGH, MEDIUM AND LOW ALLOY, IN THE CONDITION OF TEMPERED OR NOT; HADFIELD STEEL; CAST IRON; NICKEL AND ITS ALLOYS; METALLIC COVERING AND DISSIMILAR BONDS, TO PRODUCE AN APPROPRIATE MICROSTRUCTURE IN THE WELDED BOND WITHOUT THE NEED OF POST-WELDING THERMAL TREATMENT

(76) Inventor: BELA GUTH, Pituba - Salvador (BA) (BR)

Correspondence Address: NOTARO & MICHALOS P.C., 100 DUTCH HILL ROAD, SUITE 110, ORANGEBURG, NY, 10962-2100, US

(21) Appl. No.: 12/415,593

(22) Filed: Mar. 31, 2009

(30) Foreign Application Priority Data
Apr. 2, 2008 (BR) PI 0801279-2

(51) Int. Cl. B23K 28/00

(52) U.S. Cl. 219/137 R

(57) ABSTRACT

A capilary electrical welding process for the repair of carbon steel of high, medium and low alloy, in the condition of tempere dor not; Hadfield steel; cast iron; nickel and its alloys; metallic covering and dissimilar bonds, to produce an appropriate microstructure in the welded bond without the need of post-welding thermal treatment, including, initially, the preparation of the base metal for welding upon the production of appropriate holes (7), followed by the use of a ferritic-austenitic covered electrode to produce the welding layers, wherein the first layer (1) is used to cover the face of the holes (7) and to execute the root pass; the second layer (2) allows the deposit of welding fillets with microstructure and mechanical properties appropriate for the application of equipment; in the third and fifth layers (3-5), one ferritic-austenitic covered electrode is used to compose the layer, but one austenitic electrode welding fillet may be used between the welding fillets of ferritic-austenitic deposits, but always beginning with one deposit of ferritic-austenitic deposit (AF) on both sides of the hole; the fourth layer (4) is similar to the second layer, however, the welding with one electrode with microstructure and mechanical properties superior to those of one electrode used in the second layer; and the sixth layer (6) is similar to the second, however, using one electrode with microstructure and mechanical properties superior to those of the electrode used in the fourth layer.

### BACKGROUND OF THE INVENTION

This invention refers to a capillary electrical welding process for the repair of carbon steel of high, medium and low alloy in the condition of tempered or not; Hadfield steel; cast iron; nickel and its alloys; metallic covering and dissimilar bonds, to produce an appropriate microstructure in the welded bond without the need of post-welding thermal treatment.

This invention also refers to the enhancings introduced in the North-American patent Ser. No. 11/143,199, which priority is the Brazilian Industrial Patent No. 0403851-7 of the same Applicant, and in the North-American patent U.S. Pat. No. 5,272,315.

### Thermal Issues

Traditionally, in order to weld or repair carbon steel, of low, medium and high alloy, tempered or not, tools steel, Hadfield steel, cast iron, nickel and its alloys, metallic covering and dissimilar bonds, the pre-heating of the weld may be necessary, as well as the post-welding thermal treatment in order to prevent failures in the welded structure.

The cares above are not always possible to be taken, for, in general, they depend on the type of equipment to be welded, in particular to the case of repair welding. Additionally, there is a significant increase in the final cost of the equipment. Depending on the nature of the repaired material, new cracks and even premature failure of the equipment may occur.

Some foreign documents deal with the same field of application of this process, but various distinctions may be stressed, in order to prioritize the novelties and inventive activity of the object in question.

In example, in the North-American patent Ser. No. 11/143,199 and U.S. Pat. No. 5,272,315 a necessary condition is for the chamfer to present an X standard, which is fully dispensable in this process now innovated.

North-American patent Ser. No. 11/143,199 and this Brazilian patent N. 0801279-2 indicate the use of deposits of various microstructures. On its turn, North-American patent U.S. Pat. No. 5,272,315 mentions classifications of electrodes of AWS because, depending on the mechanical properties of the base metal and of the application of the part, the classifications AWS E7018, E9018, E10018, E11018 and E12018 mentioned in North-American patent U.S. Pat. No. 5,272,315 have mechanical properties which are not appropriate to some base metals, mainly the high alloy and high resistance steel. Such classifications of covered electrodes (rod electrodes) would be appropriate when the static and/or dynamic charge of the equipment was lesser than 100 tons. On the other hand, when the static and/or dynamic load of the equipment is higher than 100 tons, the mechanical properties of the consumption materials AWS E7018, E9018, E10018, E11018 and E12018 are not appropriate, such as in the case of the repair of one broken 5-ton gearing tooth or a cracked and worn-out extruder, and pieces of equipment of steel of high speed or tools.

### Purpose of the Invention

Based on the circumstances described, and in order to overcome them, including the addition of other advantages, this new technology was created, called capillary electric welding, with the aim of bonding two parts or covering a metallic surface damaged by wear and tear, with minimal dilution and without the need of post-welding thermal treatment.

One modified electric welding equipment is used for the process in question, with an open voltage above 75 V, which minimizes the overheating of the covered electrode, reduces the amount of welding spills and stabilizes the electric bow, allowing to weld thin sheets with no perforation.

The deposition of welding fillets must be intermittent and one sole continuous fillet is not allowed. Each intermittent welding fillet must have a length close to 12 cm with lateral oscillation of the electrode of up to three times its diameter. Only the root pass is deposited with a continuous string fillet technique (without oscillation).

The control of the temperature between the passes dispenses the pre or post heating of the region of the base metal to be welded. With this process, the control of the temperature between the passes depends on the thickness of the part to be welded. In case of the thickness of the metal base being lesser than or 0.5 inch it is not necessary to control the temperature between passes, once one electrode with a diameter of ⅛ inch or less is used. For the thicknesses of base metals larger than 0.5 inch, the temperature between passes must be between 100° C. and 200° C., except for all types of cast irons, in which the maximum temperature between passes must be maintained below 100° C.

Another objective of this invention resides in the fact that the hardness of the welding fillets in the second, fourth and sixth layers is between 40 to 57 HRC. AWS E7018, E9018, E10018, E11018 and E12018, which mechanical properties are superior in many times the mechanic properties of electrodes AWS 7018 to 12018.

This, the classification AWS appearing in the process of North-American patent U.S. Pat. No. 5,272,315 was replaced by the description of the microstructures present in the hard covered electrodes, to consider the diversity of the base metal and its mechanical properties covered in this patent.

### DRAWINGS DESCRIPTION

The invention is described in greater details in respect to the technique of deposition of welding fillets and to the types of welding electrodes used, shown in the attached drawings, wherein:

FIG. 1 illustrates, schematically drawn, one sectional view, which indicates a base metal depicting an amplified region which was welded or repaired, according to the procedure of this invention;

FIGS. 2 through 13 show schematically the sequence of deposition of various welding fillets, and

FIGS. 14 through 29 illustrate the progression of the deposition of welding fillets.

### DETAILED DESCRIPTION OF THE INVENTION

The region to be welded is prepared by grinding, in the case of metallic covering, or, when being chamfered, in the case of cracks in the base metal, producing V, double V, U or double U-shaped holes, depending on the thickness of the base metal. The types of covered electrodes to be used depend on the application of the equipment.

The innovated welding process provides for some initial steps (EI), important for the success to be reached, namely:

(a) The compatibility between the base metal and the electrode must be tested prior to initiating the welding;
(b) The covered electrodes must be correctly stored in order to prevent the formation of moisture in its cover, before and after the welding;
(c) Hard covered electrodes are used, instead of AWS E7018, E9018, E10018, E11018 and E12018, which welding fillet deposited in the second, fourth and sixth layers have a hardness between 40 and 57 HRC, which mechanical properties are superior in many times the mechanical properties of the electrodes AWS 7018 and 12018.

The process is continued through the preparation of the material through the step (EP). For all weldable metallic ferrous materials, with the exception of cast iron, the preparation step (EP) begins:

(a1) by the welding a cracked base metal or the formation of a wear and tear metallic covering surface after the appropriate preparation of the region, using an electrode covered with an austenitic-ferritic deposited miscrostructure, with a diameter of 3/32 inch and using the direct current electrode positive (DCEP). This electrode is used initially to dot the welding of the base metal to maintain the parts bonded;
(b1) The welder must fill in the crate prior to interrupting the electric bow, remove the slag and, should there be surface defects in the crate, they must also be removed, prior to initiating the subsequent fillet;
(c) Due to the fact of the deposition of welding fillets being intermittent, it is important to remove the reinforcement of the welding fillet in the beginning and in the end of a welding fillet by grinding to maintain its continuity and to prevent defects in the bond of the fillets.

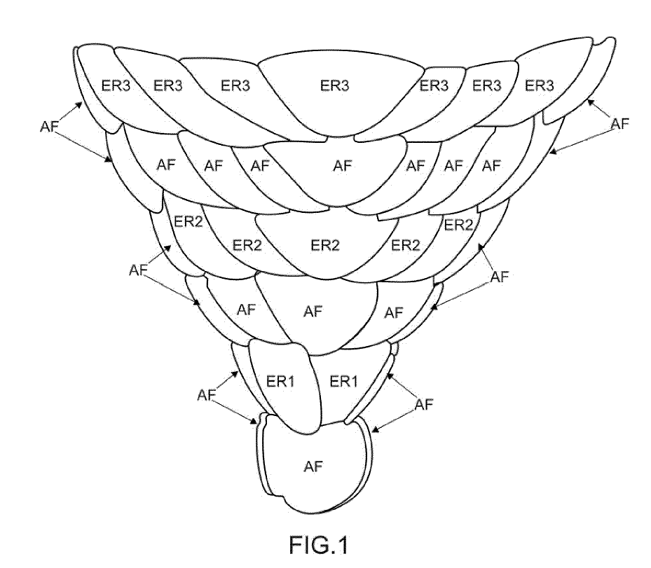

Another step of the process refers to the scheme of layers deposited (ED), described below, in which the number of layers depends on the thickness of the metal to be welded. FIG. 1 may be used as reference.

(a2) The first layer, the both sides of the holes are convered with an electrode with an austenitic-ferritic deposited miscrostructure (AF), the direct current electrode positive (DCEP) and a diameter of 3/32 inch. This covering (buttering) in the faces of the hole may be made prior to the point welding and prior to the beginning of the root pass, if the part of the equipment to be repaired allows such flexibility, or during the filling of the welding fillet, layer by layer, in the case wherein the equipment is to be in its place, with no flexibility to move the parts;
(b2) The second layer uses an electrode covered (called ER1 in FIG. 1), which deposits have a microstructure and mechanical properties appropriate for the application of the part. This electrode ER1 is deposited in the region between the deposits of ferritic-austenitic (AF) electrode, which are used to cover the faces of the hole. Depending on the situation, it is impossible to cover the faces of the hole with the electrode AF prior to welding. In this case, one AF electrode deposits fillet is formed at each side of the hole layer and, completing the layer with electrode ER1, which has mechanical properties superior to those appropriate for the application of the base metal;
(c3) The third layer is made with one layer of ferritic-austenitic (AF) electrode, or used between deposits of ferritic-austenitic (AF) electrode and austenitic deposits, up to the completion of the layer, always beginning and ending with one deposit of ferritic-austenitic (AF) electrode at both sides of the hole;
(d3) In the fourth layer, the same procedure of the second layer is used, but replacing electrode ER1 with electrode (ER2), which has mechanical properties superior to the ones of electrode ER1;
(e3) The fifth layer is constructed identical to the third one
(f3) In the sixth layer, the same procedure of the second layer is used, when using another electrode (ER3), with mechanical properties superior to electrode ER2, used in the fourth layer. Depending on the application, the ending layer is made with a deposit of ferritic-austenitic electrode (AF).

The process includes steps of application of welding for the case of one thickness of the base metal exceeding 1 inch. The deposition procedure is similar, beginning with the deposition of the first layer and so on, until the completion of the part's thickness.

The use of all six layers to fill the hole is not necessary, as described above, but the compliance with the sequence order and type of electrode to fill the hole are required.

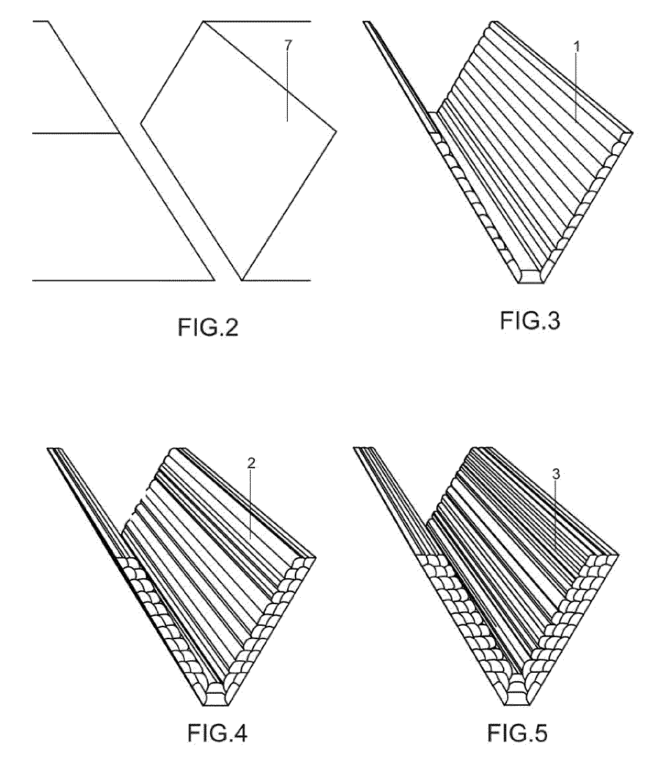

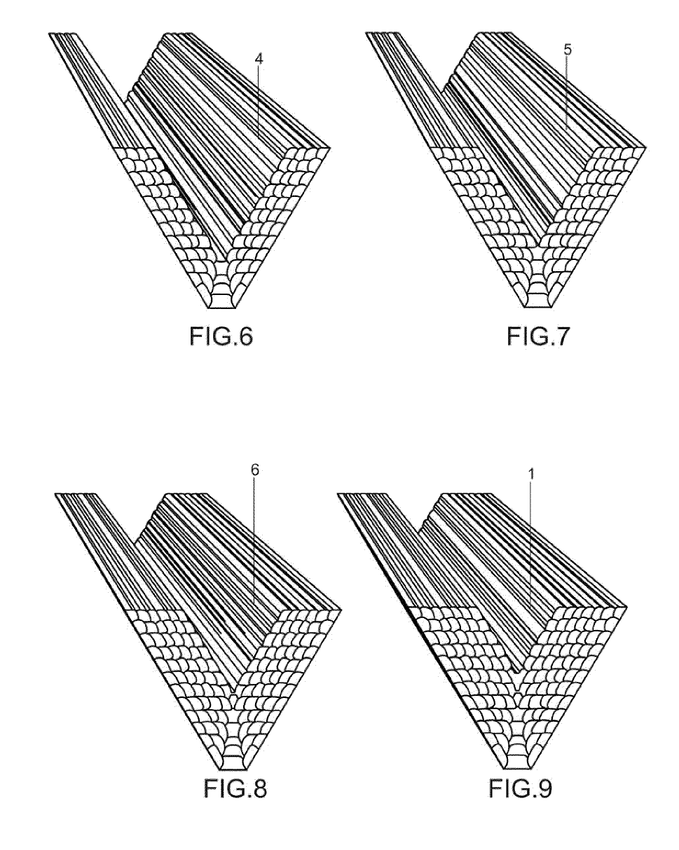

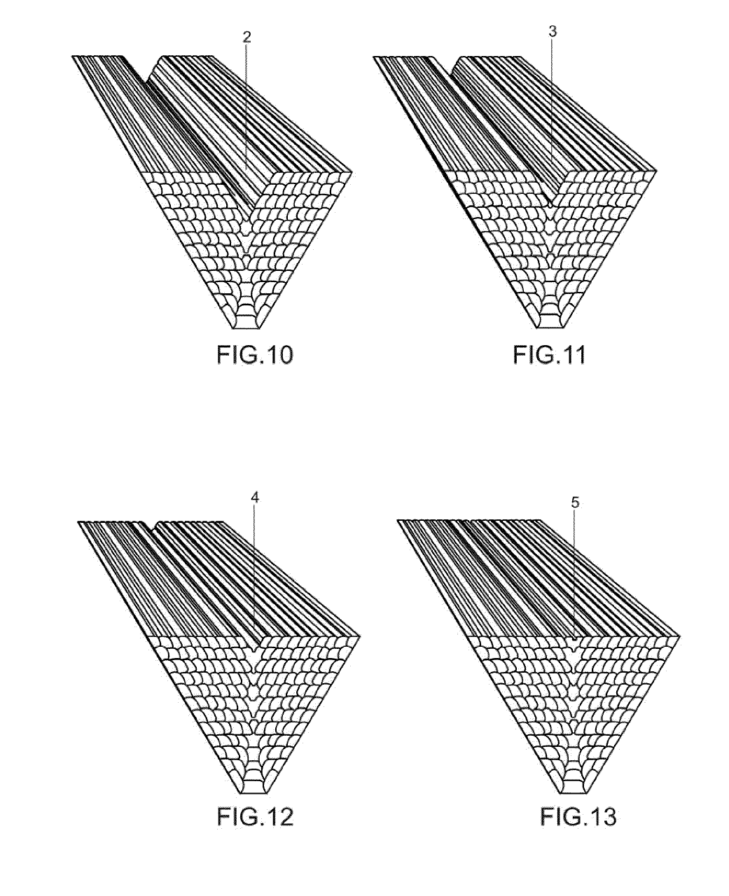

In the option of this process, presented in FIGS. 2 through 13, the technique, the step for the deposit of the layers (ED) may be defined as follows:

(a4) with the first layer destined to cover (1) the face of the hole (7) and the root pass made with the ferritic-austenitic electrode;
(b4) The second layer (2), an electrode with mechanical properties appropriate to the base metal is deposited between the ferritic-austenitic electrodes;
(c4) The third and fifth layers (3-5) use one layer of electrode totally ferritic-austenitic or one ferritic-austenitic electrode followed by one austenitic electrode, beginning and ending the deposition with one ferritic-austenitic electrode;
(d4) The fourth layer (4) is similar to the second layer, however, uses an electrode with microstructure and mechanical properties superior to the type of electrode used in the second layer;
(e5) The sixth layer (6) is also similar to the second layer, however, uses an electrode with microstructure and mechanical properties superior to the ones of the electrode used in the fourth layer;

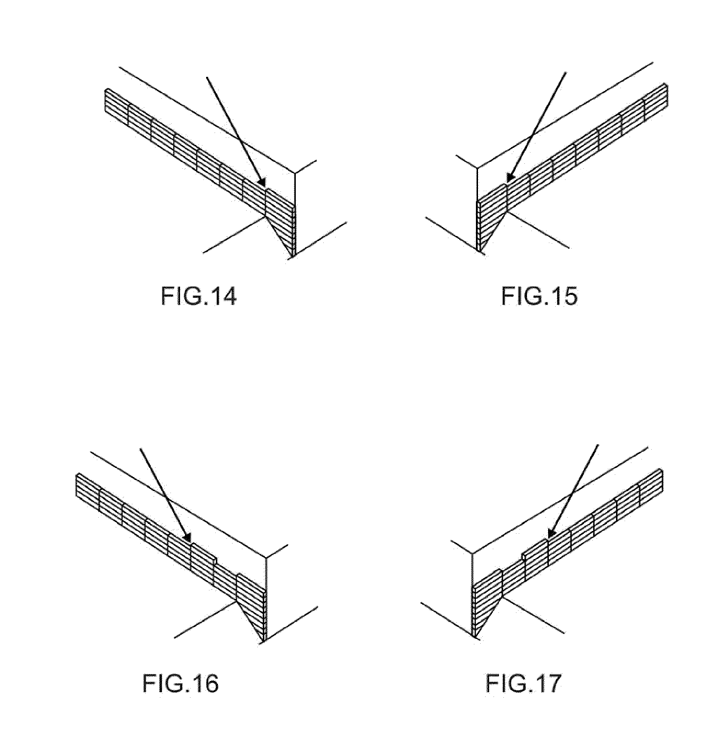

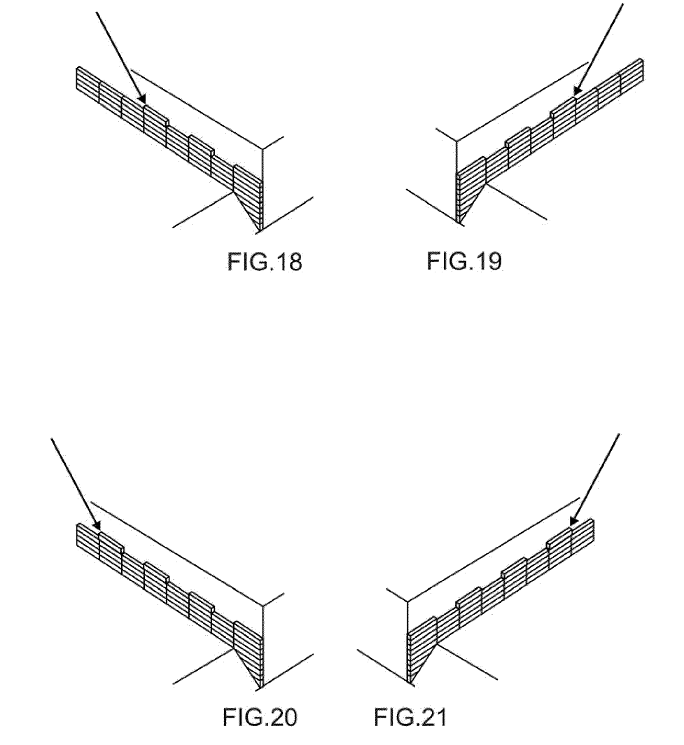

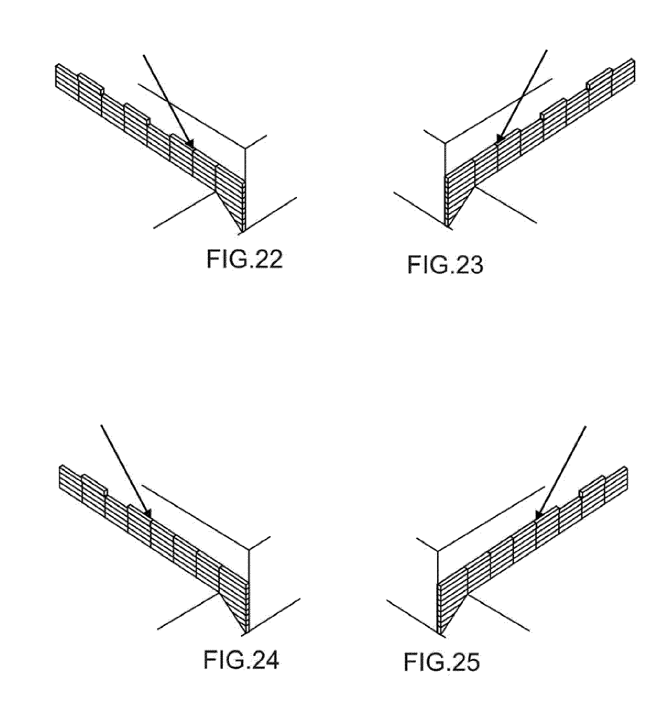

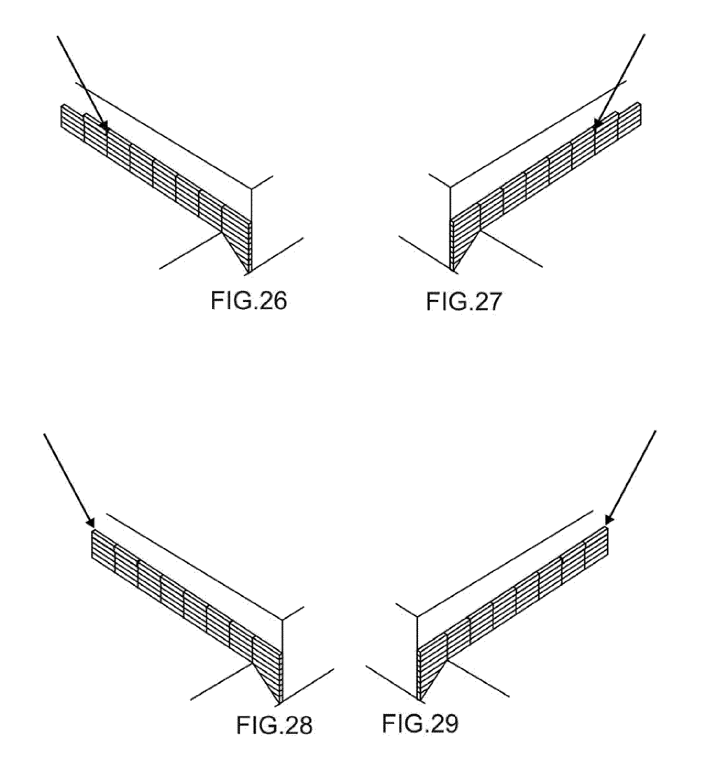

FIGS. 14 through 29 show the sequence of deposition of the welding fillets with defined lengths, at both sides of the hole to complete one welding fillet. The even figures represent one deposition sequence at one side of the hole and the odd figures represent the sequence at the opposite side of the hole.

This capillary electrical welding process provides for the hardness of the welding fillets in the second, fourth and sixth layers to be between 40 and 57 HRC. Thus, hard covered electrodes are used, which mechanical properties are superior in many times the mechanic properties of electrodes AWS 7018 through 12018.

For such, the process in question provides for the configuration for the electrode and its diameter for covering to comprehend the following characteristics:

for the welding of cast iron of any type, the covering of the faces of the hole may be made with one electrode covered with nickel or one alloy of nickel-iron, using the direct current electrode negative (DCEN) and one diameter of 3/32 inch. Should the cast iron become too contaminated due to its operation, and the fillets of nickel or nickel-iron alloy do not show any adherence to the base metal, it is recommended the use of one electrode covered with one ferritic deposit for the covering, specially made for the welding of cast iron in this condition, using the direct current electrode positive (DCEP) and the diameter of 3/32 inch;

In all types of electrodes for covering (nickel, iron-nickel alloy or ferritic deposit), the root pass and all filling passes are made with ferritic electrode, forming intermittent fillets, as shown in FIGS. 14 and 29.

The following are fundamental and innovative characteristics of the electrodes:

i) Modification of the chemical composition of the electrodes for covering: covered electrodes shall have the covering chemical composition modified so as the amount of the components of the covering which promotes the ionization in the electric bow, specially the sodium and potassium silicates, is reduced to decrease the average temperature of the electric bow and, as a consequence, reduce the dilution of the welding fillet. Thus, the localized fusion of the base metal is reduced, reducing its effect in the chemical composition of the welding pit, and thus, minimizing the formation of non-softened martensite in the partially molten region and in the zone affected by the heat, such as, for instance, in case of carbon steel and steel with carbon allow with high temperability;
ii) Avoiding the non-softened martensitic microstructure: The appropriate selection of the types of covered electrodes and of the welding parameters must be made in order to present one softened martensite microstructure in the welded bond—fusion zone and zone affected by the heat—to result in mechanical properties appropriate to the part repaired. The welding deposits producing a non-softened martensite (virgin martensite) in the welding are not appropriate to the welding procedure in question. Thus, it is possible to avoid the non-softened martensitic microstructure in the welding with the layer fillet deposition sequence, making it possible to weld all types of carbon steel with cast iron of low, medium or high alloy, metallic coverings, through welding and dissimilar bonds without post-welding thermal treatment. Therefore, the choice of the types of electrodes must be used in terms of the application of the equipment and of the base metal to be welded or repaired;
iii) Welding of low alloy steel, steel of medium and high carbon content: for the welding of low alloy steel and steel of medium and high carbon content, the covered electrodes used in the second, fourth and sixth layers, previously described in FIG. 1 may be, according to the specification of the American Welding Society—AWS, classified as covered electrode E7018 through E12018, or an equivalent specification in other international standards. The choice of the correct electrode will depend on the mechanical resistance of the base metal being repaired;
iv) Welding of high alloy steel such as tools steel and Hadfield steel: In the welding of high alloy steel, such as tools steel and Hadfield steel, the layers of deposit of the electrodes used in the second, fourth and sixth alloys may have, or not, the same chemical composition of the metal base, but the most important question are the mechanical properties of the deposit, which must be slightly higher than those of the base metal.
v) Hard covering welding: In the case of hard coverings, the covered electrodes are chosen according to the type of wear and tear mechanism, which produces deposits with a hardness superior to 450 HB, using the same procedure described in the text hereof. In other words, a covering with the ferritic-austenitic electrode will be formed, followed by another layer using alternatively a ferritic-austenitic electrode deposit, and, then, a welding fillet with a deposit appropriate for a specific wear and tear mechanism. Depending on the dimensions to be repaired, additional layers of ductile material may be necessary. In this case, the first layer begins with a deposition of ferritic-austenitic electrode in contact with the base metal, followed by an austenitic deposit, and so on, until the completion of the layer with an austenitic ferritic deposit.

The physical and mechanical properties of the base metal are preserved when the welding procedure based on the electrical capillary welding process is applied. Thus, the weld deposited remains machinable, and, as a consequence, most of the projects may be modified, such as in the applications involving high resistance alloys steel, tempered or not, and dissimilar bonds.

Despite the fact of this invention being illustrated in accordance with a currently preferred implementation, it does not limit the invention, once changes and modifications are ready to emphasize the elements mentioned in the technique considering the precedent exposure. Therefore, the invention must be limited only by the background of the following claims.

1) CAPILARY ELECTRICAL WELDING PROCESS FOR THE REPAIR OF CARBON STEEL, OF HIGH, MEDIUM AND LOW ALLOY, IN THE CONDITION OF TEMPERED OR NOT; HADFIELD STEEL; CAST IRON; 5 NICKEL AND ITS ALLOYS; METALLIC COVERING AND DISSIMILAR BONDS, TO PRODUCE AN APPROPRIATE MICROSTRUCTURE IN THE WELDED BOND WITHOUT THE NEED OF POST-WELDING THERMAL TREATMENT, wherein, most particularly, the capillary electrical welding process comprehends that, initially, the region to be welded is prepared by grinding, in the case of metallic covering, or when being chamfered, in the case of cracks in the base metal, producing V, double V, U or double U-shaped holes, depending on the thickness of the base metal, the types covered electrodes to be used depending on the application of the equipment, the chemical composition of the base metal and other information to choose the covered electrode correctly; characterized by the act of the welding beginning with one adequate prepared base metal and the use of a hard covered electrode with deposit of ferritic-austenitic microstructure, which fillet is deposited intermittently and with a hardness between 40 and 57 HRC for the second, fourth and sixth layers; being the referred electrode, according to the steps of the process, deposited as follows:
first layer—the two sides of the hole are covered with one electrode, with one ferritic-austenitic microstructure (AF) deposited, the direct current electrode positive (DCEP) and one diameter of 3/32 inch, followed by the welding of root pass with one ferritic-austenitic (AF) electrode with the direct current electrode positive (DCEP) and one diameter of 3/32 inch;
second layer—uses one covered electrode (called ER1 in FIG. 1) which deposits have a microstructure and mechanical properties appropriate for the application of the part; this electrode ER1 is deposited in the region between the ferritic-austenitic (AF) electrode deposits, which were used to cover the faces of
the hole; depending on the situation, it is impossible to cover the faces of the hole with the electrode AF prior to welding; in this case, one fillet of deposits of electrode AF is formed at each side of the hole layer, and the layer is completed with electrode ER1, with mechanical properties superior to those appropriate to the base metal application;
third layer—formed with one layer of ferritic-austenitic (AF) electrode, or used between deposits of ferritic-austenitic (AF) electrode and austenitic deposits, up to the completion of the layer, always beginning and ending with one deposit of ferritic-austenitic (AF) electrode at both sides of the hole;
fourth layer—uses the same procedure as the second layer, but replacing electrode ER1 with electrode (ER2), which has mechanical properties superior to the ones of electrode ER1 used in the second layer;
fifth layer—constructed identical to the third layer;
sixth layer—uses the same procedure as the second layer, using another electrode (ER3), with mechanical properties superior to electrode ER2, used in the fourth layer; depending on the application, the finishing layer is made with a deposit of ferritic-austenitic (AF) electrode.

2) CAPILARY ELECTRICAL WELDING PROCESS, according to claim 1, characterized by the fact of the process using modified electrical welding equipment with an open voltage of 75 V which minimizes the overheating of the covered electrode, reduces the amount of weld spills and stabilizes the electrical bow allowing the welding of thin sheets without perforation.

3) CAPILARY ELECTRICAL WELDING PROCESS, according to claim 1, characterized by the process of dispensing the pre or post heating of the base metal region to be welded.

4) CAPILARY ELECTRICAL WELDING PROCESS, according to claim 1, characterized by the temperature control between the passes depending on the thickness of the part to be welded; should the thickness of the base metal be lesser than or equal to 0.5 inch, the temperature control between the passes using an electrode with a diameter of ⅛ inch is dispensed; for the thicknesses of the base metal larger than 0.5 inch, the temperature between passes must be between 100° C. and 200° C., except for all types of cast iron, wherein the maximum temperature between passes must be maintained below 100° C.

5) CAPILARY ELECTRICAL WELDING PROCESS, according to claim 1 and preferably characterized by the fact that, in the first layer, both faces of the hole are covered with one electrode with a ferritic-austenitic (AR) infrastructure deposited, the direct current electrode positive (DCEP) and one diameter of 3/32 inch, which covering (buttering) in the faces of the hole may be made prior to the point welding and prior to the beginning of the root passing.

6) CAPILARY ELECTRICAL WELDING PROCESS, according to claim 1, characterized by the fact of the first layer, at both sides of the hole, being formed during the filling of the welding fillet, layer by layer.

7) CAPILARY ELECTRICAL WELDING PROCESS, according to claim 1, characterized by the fact that with one base metal with a thickness above 1 inch, the deposition procedure is initiated with the deposition of the first layer, and so on, until the thickness of the part is completed.

8) CAPILARY ELECTRICAL WELDING PROCESS, according to claim 1, characterized by the fact that, in the welding of cast iron, the covering of the faces of the hole may be made with an electrode covered with nickel or nickel-iron alloy, using the direct current continuous negative (DCEN) and one diameter of 3/32 inch.

9) CAPILARY ELECTRICAL WELDING PROCESS, according to claim 8, characterized by the fact that, in case of a cast iron contaminated due to its operation, and the nickel or nickel-iron alloy fillets not showing any adherence to the metal base, it is recommended the use of one electrode covered with a ferritic deposit for the covering, specially made for the welding of the cast iron in such condition, using the direct current electrode positive (DCEP) and one diameter of 3/32 inch; being all types of electrodes for covering (nickel, iron-nickel alloy or ferritic deposit), the root pass and all filling passes are made with ferritic electrode, forming intermittent fillets.

10) CAPILARY ELECTRICAL WELDING PROCESS, according to claim 1, characterized by the fact that the covered electrodes shall have the covering chemical composition modified so as the amount of the components of the covering which promotes the ionization in the electric bow, specially the sodium and potassium silicates, is reduced to decrease the average temperature of the electric bow and, as consequence, reduce the dilution of the welding fillet.

11) CAPILARY ELECTRICAL WELDING PROCESS, according to claim 1, characterized by the fact of the appropriate selection of the types of covered electrodes and of the welding parameters being chosen so as to present a softened martensite microstructure in the bond welded-fusion zone and zone affected by heat-generating mechanical properties appropriate to the part repaired;

12) CAPILARY ELECTRICAL WELDING PROCESS, according to claim 1, characterized by the fact of the appropriate electrodes avoiding the non-softened martensitic microstructure in the welding with the layer fillet deposition sequence, making it possible to weld all types of carbon steel with cast iron of low, medium or high alloy, metallic coverings, through welding and dissimilar bonds without post-welding thermal treatment.

13) CAPILARY ELECTRICAL WELDING PROCESS, according to claim 1, characterized by the fact of in the welding of low alloy steel and steel of medium and high carbon content, the covered electrodes used in the second, fourth and sixth layers may be classified as covered electrode E7018 through E12018, or one equivalent specification in other international standards.

14) CAPILARY ELECTRICAL WELDING PROCESS, according to claim 1, characterized by the fact of the welding of high alloy steel, such as tools steel and Hadfield steel, the layers of the electrodes used in the second, fourth and sixth alloys may have, or not, the same chemical composition of the metal base, provided that the mechanical properties of the deposit are slightly higher than those of the base metal.

15) CAPILARY ELECTRICAL WELDING PROCESS, according to claim 1 and in the case of repair of hard coverings, the covered electrodes are chosen according to the type of wear and tear mechanism, which produces deposits with a hardness superior to 450 HB, characterized by the fact of the welding process using a coating with ferritic-austenitic electrode, followed by another layer, using alternately one ferritic-austenitic electrode deposit and, then, one welding fillet with one deposit appropriate for a specific wear and tear mechanism.

16) CAPILARY ELECTRICAL WELDING PROCESS, according to claim 1, depending on the dimensions which must be repaired, optional layers of ductile material may be necessary, characterized by the fact of the first layer beginning with one deposition of ferritic-austenitic electrode in contact with the base metal, followed by one austenitic deposit, and so on, until the completion of the layer with one ferritic-austenitic deposit.

17) CAPILARY ELECTRICAL WELDING PROCESS, according to claim 1, characterized by the fact of the physical and mechanical properties of the base metal being preserved when the welding procedure based on the capilary electrical welding is applied, and, thus, the weld deposited remains machinable, and, as consequence, the largest part of the projects may be modified, such as in the applications involving steel of high resistance alloys, tempered or not, and dissimilar bonds.

18) CAPILARY ELECTRICAL WELDING PROCESS, according to claim 3, characterized by the temperature control between the passes depending on the thickness of the part to be welded; should the thickness of the base metal be lesser than or equal to 0.5 inch, the temperature control between the passes using an electrode with a diameter of ⅛ inch is dispensed; for the thicknesses of the base metal larger than 0.5 inch, the temperature between passes must be between 100° C. and 200° C., except for all types of cast iron, wherein the maximum temperature between passes must be maintained below 100° C.

19) CAPILARY ELECTRICAL WELDING PROCESS, according to claim 15, depending on the dimensions which must be repaired, optional layers of ductile material may be necessary, characterized by the fact of the first layer beginning with one deposition of ferritic-austenitic electrode in contact with the base metal, followed by one austenitic deposit, and so on, until the completion of the layer with one ferritic-austenitic deposit.
